(19) United States
(12) Patent Application Publication
(10) Pub. No.: US 2026/0339537 A1
(43) Pub. Date: Oct. 29, 2026

(54) Coordinated Multi-Module Page Migration

(71) Applicant: Micron Technology, Inc., Boise, ID (US)

(72) Inventor: Poorna Kale, Folsom, CA (US)

(21) Appl. No.: 19/188,748

(22) Filed: Apr. 24, 2025

(51) Int. Cl. G06F 3/06

(52) U.S. Cl. CPC G06F 3/0647; G06F 3/0604; G06F 3/0656; G06F 3/0685

(57) ABSTRACT

A method, including: receiving, in a migration coordinator and from a plurality of memory sub-systems connected to a compute express link (CXL) fabric, a plurality of requests to migrate hosting of memory pages of a secondary random access memory implemented using the memory sub-systems; determining, by the migration coordinator, source and destination locations of migration of the memory pages; grouping, by the migration coordinator, first memory pages having first data in a common source memory sub-system of the migration for a first bulk transfer of data to a buffer memory; grouping, by the migration coordinator, second memory pages having second data in a common destination memory sub-system of the migration for a second bulk transfer of data from the buffer memory; and scheduling, by the migration coordinator, the first bulk transfer and the second bulk transfer based on monitoring communications activities in the fabric.

### TECHNICAL FIELD

At least some embodiments disclosed herein relate to memory systems in general and, more particularly but not limited to, memory systems having memories of different characteristics.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a memory sub-system having a page migration engine configured according to one embodiment.

FIG. 3 shows an example of memory sub-systems having a page migration engine configured according to one embodiment.

FIG. 4 shows a buffer chip configured with a page migration queue according to one embodiment.

FIG. 5 illustrates a page migration queue according to one embodiment.

FIG. 6 shows a method of autonomous page migration within a heterogeneous memory sub-system according to one embodiment.

FIG. 7 shows a controller of a compute express link fabric configured with a migration coordinator according to one embodiment.

FIG. 8 shows a compute express link fabric configured with a controller to coordinate page migrations according to one embodiment.

FIG. 9 shows a compute express link switch configured to implement a memory manager according to one embodiment.

FIG. 10 shows a migration coordinator according to one embodiment.

FIG. 11 shows a method to migrate pages across memory sub-systems according to one embodiment.

FIG. 12 is a block diagram of an example computer system in which embodiments of the present disclosure can operate.

### DETAILED DESCRIPTION

Different types of memories can have different trade-offs in performance, cost, capacity, power consumption, endurance, etc. For example, NAND flash memory is non-volatile in that it can retain data without being connected to a power supplier; and dynamic random access memory (DRAM) is volatile in that data stored in it can be corrupted or lost if a power supplier is disconnected from it for a short period (e.g., during a power outage event). NAND flash memory is less expensive than DRAM in offering a large capacity and thus is typically used in solid-state drives as storage media. DRAM can have an access speed, and endurance, much higher than NAND flash memory and thus is typically used as the main memory of a computer system.

When the demand for memory resources from the main memory exceeds its capacity in a computer system, the operating system of the computer system can swap some of the memory pages in the main memory to a storage device, such as a solid-state drive. For example, data in a memory page that is not in active use can be stored into the storage device to swap the memory page out of the main memory into the storage device; and the state of the memory page is preserved in the storage device such that the memory page can be freed and reused to store new data. When the memory page corresponding to the data being stored in the storage device is to be accessed, the memory page previously swapped into the storage device can be swapped back from the storage device into the main memory by reading the data from the storage device. The data can be read into a memory page (e.g., the same memory page when it is not being in active use, or another memory page that is not in active used) to restore the state of the memory page. Accessing to the memory page can then be directed to the memory page having the state restored from the storage device.

The operations of swapping memory pages between the main memory and the storage device can cause significant overhead for the processing device of the computer system and cause significant latencies in memory access.

At least some aspects of the present disclosure address the above and other deficiencies and challenges by configuring memories of different characteristics (e.g., NAND flash memory and DRAM) in a same hybrid memory module to provide memory services in a unified way to a host system. A hardware-accelerated page migration engine is configured in the hybrid memory module to intelligently manage data movements across the memories of different characteristics within the memory module to reduce burdens on the host system and to reduce latencies.

For example, the hybrid memory module can be connected to the host system via a compute express link (CXL) connection such that the host system can access the memories of different characteristics (e.g., NAND flash memory and DRAM) using a same memory access protocol (e.g., CXL.mem with cache coherency). The hybrid memory module has an address translation logic configured to translate the memory address of a memory access request received over the CXL connection to a physical memory address in the hybrid module. When the hybrid memory module determines or predicts that the host system is to access a memory page that is currently mapped to a slower memory (e.g., NAND flash memory), the page migration engine can move data of the memory page within the memory module to implement the memory page using a faster memory (e.g., DRAM). Thus, subsequent memory accesses made by the host system to the memory page can have an improved performance level without instructions from the host system to control and/or perform the page migration. Since the hybrid memory module includes non-volatile memory (e.g., NAND flash), the hybrid memory module can also function as a persistent data storage device. The hybrid memory/storage module can be used to provide enhanced capacity accessible to a host system through the CXL.mem interface and a memory access protocol. Autonomous and intelligent page migration allows the hybrid memory module to offer efficient utilization of different media types or memory tiers (e.g., NAND flash memory and DRAM).

For example, the hybrid memory module can have an integrated, specialized hardware engine to perform autonomous page migration across different memory media with no intervention or minimal intervention from the host system. The hybrid memory module can have data buffer chip architecture to implement data movement, and to perform page migration with prediction capabilities. Autonomous and predictive page migration can reduce latencies, reduce host/controller overhead in media management, improve efficiency in utilization of media bandwidth, reduce power consumption, and/or maintain memory/cache coherency. For example, the hybrid memory module can be connected to a CXL fabric to provide or enlarge a secondary random access memory of a computer system by expanding upon the memory capacity of the main memory of the computer system.

Optionally, the hybrid memory module can include different types of media/memory tiers (e.g., NAND flash memory and DRAM), a control unit, a page migration engine, a page translation unit, and a queuing system.

The control unit can be implemented using dedicated hardware in a data management buffer chip. The control unit can control an interface to a CXL connection, and different media interfaces to memory chips of different types. For example, a double data rate (DDR) interface can be controlled by the control unit to operate on one or more DRAM memory chips; and an open NAND flash interface (ONFI) can be controlled by the control unit operate on one or more NAND memory chips. Optionally, the control unit can further include power and thermal sensing circuits to control the power usages and/or thermal states of the hybrid memory module.

The page migration engine can include one or more direct memory access (DMA) engines configured to operate on the memory chips via the media interfaces (e.g., DDR/ONFI interface). The page migration engine can have buffers of different page sizes optimizes for respective media (e.g., 4 KB/8 KB for DRAM memory and one or more MBs for NAND flash memory). The page migration engine can further include error detection and correction circuits to protect integrity of data to or from the media using error correction code (ECC) techniques.

The page translation unit can include hardware for memory address translation and caching capabilities for address translation tables. The page translation unit can manage page states of memory pages within the hybrid memory module.

The queuing system can enable priority-based migration queues along with logic to stitch pages together. The queuing system can manage dependencies of pages to be migrated and operate on the principles of quality of service (QoS).

In a typical sequence of operations, the memory module receives a memory access request through its CXL.mem interface. The control unit can determine, in response to the memory access request, whether to migrate a memory page and if so, send a migration request to the page migration engine with a priority assignment. For example, a memory page in a NAND flash memory chip being accessed via the memory access request can be migrated to a DRAM memory chip; and optionally, a memory page in a DRAM memory chip that is not likely to be used in a next period of time can be migrated to a NAND flash memory chip to free up resources in the DRAM memory chip. The page migration engine can perform a resource availability check, and perform address translation. To perform a page migration, a DMA transfer is initiated, and error handling performed. After data is delivered, the translation table is updated. After a status update, resources used in the page migration operation can be cleared and released for processing the next page migration request.

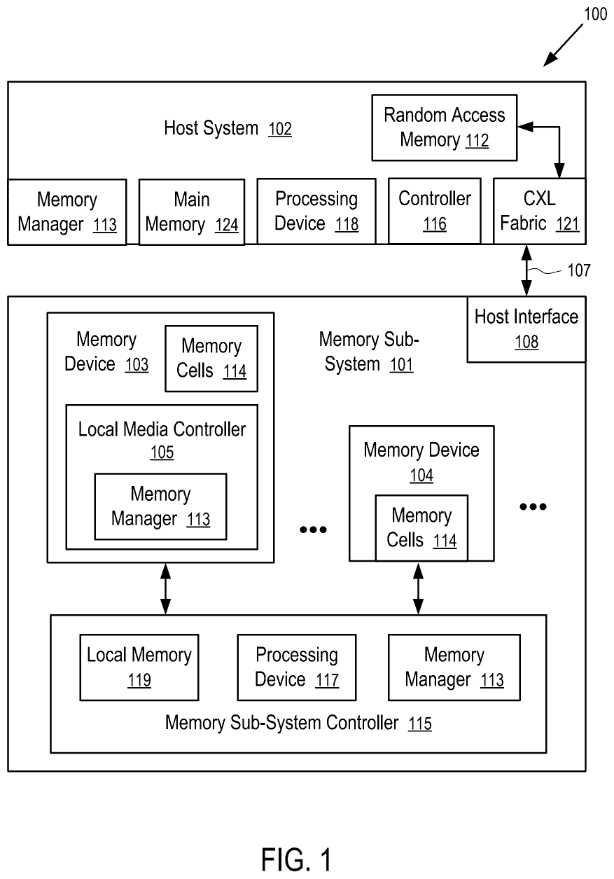

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media card (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a memory manager 113 configured to perform operations related to the management of the secondary random access memory 112 attached to the processing device 118 of the host system 102 via a compute express link (CXL) fabric 121. In some embodiments, the controller 115 in the memory sub-system 101 includes at least a portion of the memory manager 113. In other embodiments, or in combination, the fabric 121, the controller 116 and/or the processing device 118 in the host system 102 can include at least a portion of the memory manager 113. For example, the fabric 121, the controller 115, the controller 116, and/or the processing device 118 can include logic circuitry implementing the memory manager 113. For example, the switches and/or controller of the fabric 121, the controller 115, or the processing device 118 (processor) of the host system 102, can be configured to execute instructions stored in memory for performing the operations of the memory manager 113 described herein. In some embodiments, the memory manager 113 is implemented in an integrated circuit chip disposed in the memory sub-system 101 or a controller of the fabric 121. In other embodiments, the memory manager 113 can be part of firmware of the memory sub-system 101, an operating system of the host system 102, a device driver, a set of agents running in CXL switches of the fabric 121, a part of a fabric manager running a controller of the CXL fabric 121, or an application, or any combination thereof.

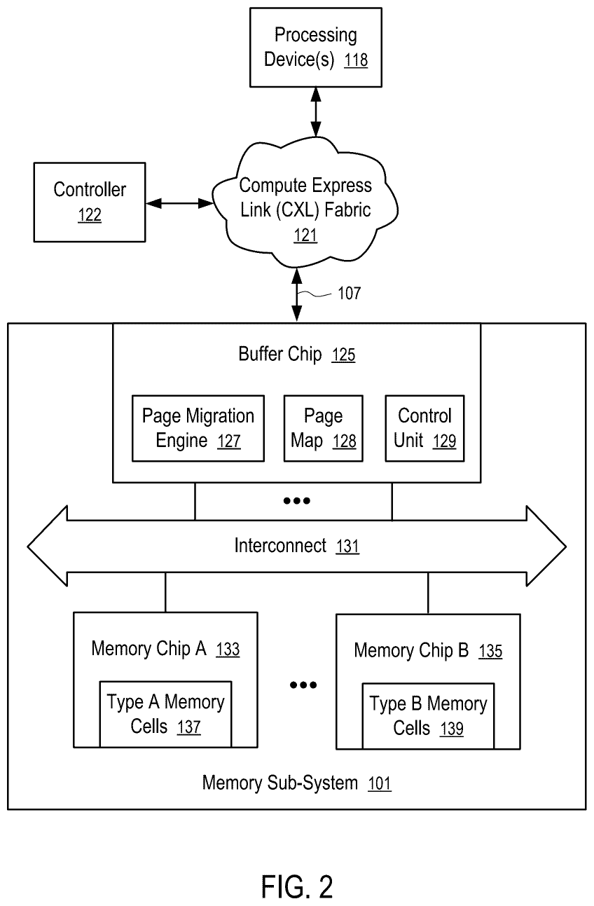

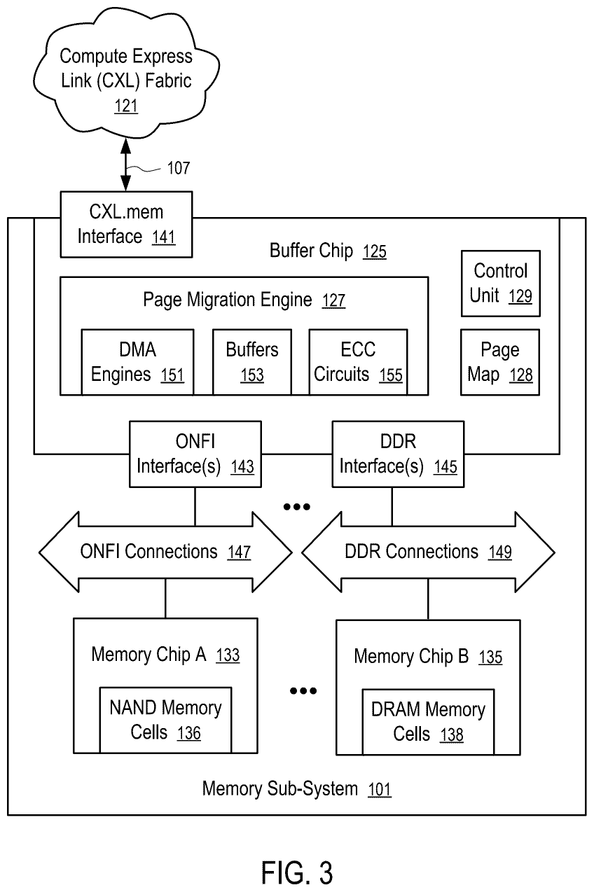

The random access memory 112 can be implemented using one or more memory devices attached to the CXL fabric 121 and/or the memory sub-system 101 to supplement the main memory 124. For example, the memory sub-system 101 can be configured with a page migration engine 127 as illustrated in, and further discussed below in connection with, FIG. 2 and FIG. 3.

FIG. 2 shows a memory sub-system having a page migration engine configured according to one embodiment. For example, the memory sub-system 101 of FIG. 1 can be implemented in a way as illustrated in FIG. 2 to provide at least a portion of the secondary random access memory 112 for the processing device(s) 118 in the host system 102.

In FIG. 2, the memory sub-system 101 includes a buffer chip 125 is configured as a gateway between memory chips 133, . . . , 135 in the memory sub-system 101 and a connection 107 to the memory sub-system 101.

For example, a processing device 118 can be connected to the memory sub-system 101 through the connection 107 with a compute express link (CXL) fabric 121. The compute express link fabric 121 can have one or more CXL switches controlled by a controller 122.

A conventional buffer chip is typically used in a server memory module to maintain signal integrity and to allow a higher number of dual in-line memory module (DIMM) slots per channel as well as support low-power applications. For example, a fully buffered DIMM (FB-DIMM) can have an advanced memory buffer (AMB) to compensate for signal deterioration by buffering and resending the signal.

The buffer chip 125 in the memory sub-system 101 can not only compensate for signal deterioration but also perform page migration operations to change how memory resources in the memory chips 133, . . . , 135 are used.

For example, a memory chip 133 can include memory cells 137 of a first type (e.g., NAND flash memory to offer increased capacity at a low cost and persistent storage capability). For example, a memory chip 135 can include memory cells 139 of a second type (e.g., DRAM to offer improved performance in latency, bandwidth, endurance).

The buffer chip 125 can include a page map 128 that determines where a memory page being accessed over the connection 107 is physically located. For example, during one period of operation of the memory sub-system 101, a memory address in a memory page addressed over the connection 107 can be in the memory chip 133; and during another period of operation of the memory sub-system 101, the memory page can be in the memory chip 135. The page migration engine 127 can perform page migration operations to change the page map to best utilize the memory resources in the memory chips 133, . . . , 135 of the memory sub-system 101.

The buffer chip 125 can include a page migration engine 127, and a control unit 129 configured to control the operations of page migration engine 127. After a page migration operation is submitted to the page migration engine 127, the page migration engine 127 can perform operations to migrate a page in the background without further assistance from the control unit 129.

For example, to move a memory page that is currently in the memory chip 135 to the memory chip 133, the page migration engine 127 can use a direct memory access (DMA) engine to store the data of the memory page in the source memory chip 133 to the destination memory chip 133 over the interconnect 131 among the buffer chip 125 and the memory chips 133, . . . , 135. Once the data of the memory page is in the destination memory chip 133, the page migration engine 127 and/or the control unit 129 can update the page map 128 to direct access to the memory page to the memory chip 133. Similarly, the page migration engine 127 can migrate a memory page from the memory chip 133 to the memory chip 135.

In some implementations, the memory sub-system 101 is configured to offer a memory capacity that is substantially equal to the sum of the capacities of the memory chips 133, . . . , 135. A portion of the non-volatile capacity of the memory chips 133, . . . , 135 (e.g., implemented via memory cells of a non-volatile type, such as NAND flash memory) can be reserved for the persistent storage of the page map 128. Optionally, a further portion of the non-volatile capacity of the memory chips 133, . . . , 135 can be reserved as free memory resources to facilitate page migration operations and/or to be used as replacement of bad/damaged memory pages or blocks.

In such implementations, the memory sub-system 101 can offer a memory capacity that includes a first portion that is volatile (e.g., implemented using memory cells of a volatile type, such as DRAM) and a second portion that is non-volatile (e.g., implemented via memory cells of a non-volatile type, such as NAND flash memory). Through page migration operations, some memory pages in the second, non-volatile portion can be migrated to a memory chip (e.g., 135) having volatile memory (e.g., to improve the performance level in accessing the memory pages). In response to an indication of a power outage event (or a command to shut down), the page migration engine 127 can migrate such pages back to a memory chip(s) (e.g., 133) having memory cells of the non-volatile type.

Alternatively, the sub-system 101 is configured to offer a memory capacity that is substantially equal to the sum of the capacities of the non-volatile memory chips (e.g., 133) in the memory sub-system 101. The volatile memory chips (e.g., 135) in the memory sub-system 101 are used by the control unit 129 to host actively used memory pages. For example, the control unit 129 can be configured to use the volatile memory chips (e.g., 135) as a cache memory to access the memory pages in the non-volatile memory chips (e.g., 133). In response to an indication of a power outage event (or a command to shut down), the page migration engine 127 can migrate such pages back to a memory chip(s) (e.g., 133) having memory cells of the non-volatile type. Thus, the entire capacity offered by the memory sub-system 101 can be considered non-volatile.

In some implementations, the control unit 129 can track the usages of memory pages hosted in a volatile memory chip (e.g., 135). When a memory page is not in active use for a period longer than a threshold, the control unit 129 can request the page migration engine 127 to migrate the page to a non-volatile memory chip (e.g., 133) to free up resources in the volatile memory chip (e.g., 135). Freeing up the resources can allow an actively used memory page to be migrated to the volatile memory chip (e.g., 135) or selectively powering down (or entering a low power mode) sections of the memory chip (e.g., 135) (or the entire memory chip 135) to reduce power consumption.

FIG. 3 shows an example of memory sub-systems having a page migration engine configured according to one embodiment. For example, the memory sub-system 101 of FIG. 1 and/or FIG. 2 can be implemented in a way as illustrated in FIG. 3 to provide at least a portion of the secondary random access memory 112 for the processing device(s) 118 in the host system 102.

In FIG. 3, the memory sub-system 101 has a single external-facing interface, such as a CXL.mem interface 141 operable on a connection 107 to a compute express link (CXL) fabric 121. The CXL.mem interface 141 can be configured to support memory access requests in compliance with a protocol standard of CXL.mem.

The control unit 129 of the buffer chip 125 is configured to generate memory access responses to requests received in the CXL.mem interface 141.

The buffer chip 125 can have a plurality of internal-facing interfaces to access the memory chips 133, . . . , 135 of different characteristics.

For example, a memory chip 133 has NAND memory cells 136 that can be access via an ONFI interface 143 over ONFI connections 147 provided within the memory sub-system 101.

For example, a memory chip 135 has DRAM memory cells 138 that can be access via a DDR interface 145 over DDR connections 149 provided within the memory sub-system 101.

The page migration engine 127 in FIG. 3 has a plurality of DMA engines 151 to transfer data between buffers 153 in the buffer chip 125 and memory chips 133, . . . , 135.

For example, the page migration engine 127 can have a DMA engine adapted to read data from and write data to a NAND memory chip (e.g., 133) using an ONFI interface 143, and a separate DMA engine adapted to read data from and write data to a DRAM memory chip (e.g., 135) using an ONFI interface 143.

The NAND memory cells 136 are generally less reliable than DRAM memory cells 138 in data storage and retrieval. The page migration engine 127 can include error correction code (ECC) circuits 155 to generate redundant information for writing data to the NAND memory chips (e.g., 133) and to decode the data with redundant information retrieved from the NAND memory chips (e.g., 133).

Optionally, the buffer chip 125 can also include ECC circuits 155 adapted to enhance data integrity for reading from and writing to DRAM memory chips (e.g., 135).

For example, different DMA engines 151 of the page migration engine 127 can be used in parallel to transfer data between the buffers 153 and the memory chips (e.g., 133 and 135) to perform page migration operations in the background while the control unit 129 is servicing memory access requests received in the CXL.mem interface 141 using other internal-facing interfaces to memory chips in the memory sub-system 101.

For example, in response to a memory access request received in the CXL.mem interface 141, the control unit 129 can determine from the page map 128 that the memory address identified in the memory access request is in a memory page currently hosted in the NAND memory chip 133. The control unit 129 can access the memory chip 133 to retrieve data from the NAND memory chip 133 into the buffers 153 to generate a response to the memory access request. The latency of retrieving the data from the NAND memory chip 133 is longer than retrieving the data from the DRAM memory chip 135. The control unit 129 can determine that further access to the memory page can occur in a next period of time; and in response, the control unit 129 can generate a request for the page migration engine 127 to migrate the memory page to the DRAM memory chip 135. The migration operation can be performed using at least in part the data in the buffers 153.

After the page migration request is dispatched to the page migration engine 127, the control unit 129 can further service subsequent memory access requests received in the CXL.mem interface 141.

Typically, a smallest unit of data (e.g., 512 bytes or 4 KB) that can be retrieved by the buffer chip 125 and error corrected using the ECC circuits 155 can be significantly larger than the size (e.g., one byte or 32 bytes, or 64 bytes, or 128 bytes) of the data requested by a memory access request received in the CXL.mem interface 141. Thus, one of the subsequent memory access requests can be directed to a portion of the data that is already in the buffer 153; and the control unit 129 can generate a response using the data in the buffer 153, while the page migration engine 127 migrates the memory page to the DRAM memory chip 133 in the background. The subsequent memory access requests can also include accesses to other memory pages (e.g., a page in the DRAM memory chip 135 or another memory chip in the memory sub-system 101).

After the completion of the migration of the memory page, the page migration engine 127 and/or the control unit 129 can update the page map 128. The buffer 153 storing the data for the memory page can be freed; and subsequent accesses to the memory page can be serviced via the control unit 129 access the DRAM memory chip 135 using a DDR interface 145.

When the control unit 129 determines that the memory page in the DDR memory chip 135 becomes cold (e.g., having not been accessed via the CXL.mem interface 141 for a period of time longer than a threshold), the control unit 129 can send a page migration request to the page migration engine 127 to migrate the memory page to a NAND memory chip 133.

When a section of the DRAM memory chip 135 has no valid data, the control unit 129 can instruct the DRAM memory chip 135 to place the section in a low power mode and/or shut down the section.

When the DRAM memory chip 135 has no valid data, the control unit 129 can instruct the DRAM memory chip 135 to enter a low power mode and/or to shut down.

Thus, the operations of the page migration engine 127 allows the control unit 129 to best utilize the resources of the memory chips 133, . . . , 135 for overall performance in capacity, latency, bandwidth, endurance, and data integrity, and to improve or optimize power usages of the memory sub-system 101.

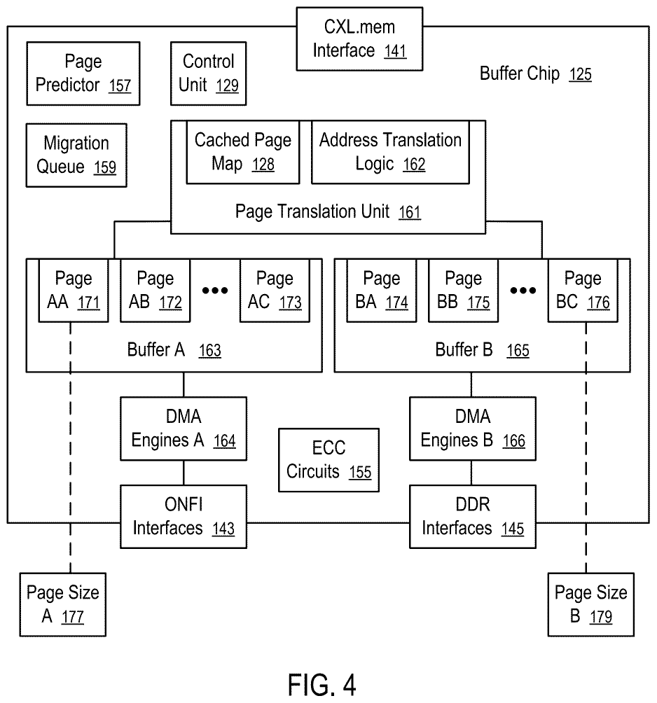

FIG. 4 shows a buffer chip configured with a page migration queue according to one embodiment. For example, the buffer chips 125 in FIG. 2 and FIG. 3 can be implemented in a way as illustrated in FIG. 4.

In FIG. 4, the buffer chip 125 includes one or more DMA engines 164 to access NAND memory chips (e.g., 133) via one or more ONFI interfaces using a protocol standard of ONFI (e.g., over ONFI connections 147). Further, the buffer chip 125 includes one or more DMA engines 166 to access DRAM memory chips (e.g., 135) via one or more DDR interfaces using a protocol standard for DDR memory bus (e.g., over DDR connections 149).

The buffer chip 125 has a buffer 163 configured to buffer data read from or to be written to NAND memory chips (e.g., 133). The buffer 163 has pages 171, 172, . . . , 173, each having a same page size 177 optimized for throughput and/or memory bandwidth accessing NAND memory chips (e.g., 133).

The buffer chip 125 has a buffer 165 configured to buffer data read from or to be written to DRAM memory chips (e.g., 135). The buffer 165 has pages 174, 175, . . . , 176, each having a same page size 179 optimized for throughput and/or memory bandwidth in accessing DRAM memory chips (e.g., 133).

The page size 179 (e.g., 4 KB or 8 KB) for DRAM access is smaller than the page size 177 (e.g., one GB or larger) for NAND access.

For example, a page (e.g., 171) for NAND access can contain multiple pages (e.g., 174, 175, . . . ) for DRAM access. To migrate memory pages from a DRAM memory chip (e.g., 135) to a NAND memory chip (e.g., 133), the buffer chip 125 can stitch multiple pages (e.g., 174, 175, . . . ) of DRAM data in a page (e.g., 171) for NAND access for a DMA engine 164 to write into a NAND memory chip (e.g., 133).

To protect integrity of data stored in a NAND memory chip (e.g., 133), the buffer chip 125 can use ECC circuits 155 to generate redundant information using an error correction code technique, such as low-density parity check (LDPC). When retrieving data from a NAND memory chip (e.g., 133), the buffer chip 125 can use the ECC circuit 155 to detect and correct random bit errors using the error correction code technique to recover error free data into the buffer 163.

After a page (e.g., 171) of data is retrieved from a NAND memory chip (e.g., 133), the buffer chip 125 can separate them into multiple pages (e.g., 174, 175, . . . ) of the size 179 for DRAM access. Optionally, the buffer chip 125 can migrate the set of pages (e.g., 174, 175, . . . ) corresponding to the entire page (e.g., 171) of NAND data into one or more DRAM memory chips (e.g., 135). Alternatively, the buffer chip 125 can migrate a subset of the pages of the size 179, selected from the page (e.g., 171) of NAND data for migration into one or more DRAM memory chips (e.g., 135).

The buffer chip 125 has a page translation unit 161 having an address translation logic 162 and a cached page map 128. A memory page as known to the external world outside of the CXL.mem interface 141 can be mapped to a page in a DRAM memory chip (e.g., 135), a portion of a page in a NAND memory chip (e.g., 133), or a page in a buffer (e.g., 163, 165) while the migration of the page is in progress. The control unit 129 can use the address translation logic 162 to translate, using the cached page map 128, the memory address identified in a memory access request received in the CXL.mem interface 141 and service the request using a buffer (e.g., 163 or 165) a memory chip (e.g., 133 or 135) as identified by the result of the address translation.

The buffer chip 125 in FIG. 4 includes a page predictor 157 configured to identify, based on activities of memory access requests received in the CXL.mem interface 141, candidate pages for page migration.

For example, when one or more memory access requests received in the CXL.mem interface 141 address a memory page currently hosted in a NAND memory chip (e.g., 133) and/or having data buffered in the buffer 163, the page predictor 157 can predict that more subsequent memory access requests will be directed to the memory page. In response, the page predictor 157 can enter into a migration queue 159 a request to migrate the memory page to a DRAM memory chip (e.g., 135).

For example, when the memory access requests received in the CXL.mem interface 141 has a sequential pattern of access and is expected to access a page that is currently hosted in a memory chip (e.g., 133) having a lower performance level than another memory chip (e.g., 135), the page predictor 157 can add a page migration request to the queue 159 to preemptively migrate the page to the faster memory chip (e.g., 135). When the migration completes before a memory access request addressing the memory page is received in the CXL.mem interface 141, a response to the memory access request can be provided with a shorter latency than generating the response using the slower memory chip (e.g., 133).

For example, when one or more memory pages in a DRAM memory chip (e.g., 135) have not been accessed via the CXL.mem interface 141 for a period longer than a threshold, the page predictor 157 can predict that further memory access requests received subsequently in the CXL.mem interface 141 are not likely to address the one or more memory pages. In response, the page predictor 157 can enter into a migration queue 159 a request to migrate the one or more memory pages to a NAND memory chip (e.g., 133) for persistent storage, reduced power consumption in the DRAM memory chip (e.g., 135), and/or freed memory resources that can be used to host another memory page for active use.

The buffer chip 125 can prioritize the requests in the migration queue 159 to schedule their execution for improve performance. For example, when a page is predicted to be accessed in a next period of time, the priority of the request can be set to be high to maximize the performance in responding to requests to access the page. For example, when the free memory resources in a DRAM memory chip (e.g., 135) is low, the requests to migrate pages from the DRAM memory chip (e.g., 135) can be assigned a high priority to allow memory pages to be migrated into the DRAM memory chip (e.g., 135). Thus, the buffer chip 125 can execute the requests in the queue 159 based on the priorities of the requests in the queue and thus out of the order in which the requests are entered into the queue 159.

In some instances, the priorities of page migration requests are assigned based at least in part on the quality of service (QoS) identified in memory requests in the CXL.mem interface 141. For example, the CXL.mem interface 141 can receive two interleaved sequences of memory access requests that are predicted to access two separate memory pages hosted in a NAND memory chip 133. The page predictor 157 can enter requests to migrate the two pages with priority levels assigned according to QoS indicators provided sequences of memory access requests such that the migration of a page predicted to be accessed by memory access requests with a high QoS indicator is assigned a high priority level, and the migration of a page predicted to be access by memory access request with a low QoS indicator is assigned a low priority level.

In some instances, the buffer chip 125 can aggregate multiple requests for migration from one or more DRAM memory chip (e.g., 135) to generate a page of the size 177 for migration into a NAND memory chip (e.g., 133) as one request.

In some instances, the buffer chip 125 can separate a request for migration of NAND data in a page (e.g., 171) in the buffer into a plurality of requests for migrating from pages (e.g., 174, 175, . . . ) for different DRAM memory chips (e.g., 135).

In some implementations, the buffers 163 and 165 are configured in one or more DRAM memory chips (e.g., 135) that have a higher level of performance and/or endurance than a NAND memory chip (e.g., 133).

FIG. 2 to FIG. 4 are discussed and/or illustrated using a NAND memory chip (e.g., 133) as an example of non-volatile memory chip. Other types of non-volatile memory chips can also be used, such as a NOR flash memory chip, a cross-point memory chip. Similarly, FIG. 2 to FIG. 4 are discussed and/or illustrated using a DRAM memory chip (e.g., 135) as an example of volatile memory chip. Other types of volatile memory chips can also be used, such as an SRAM memory chip. Thus, the implementation of a memory sub-system 101 is not limited to the use of NAND memory chips (e.g., 133) and DRAM memory chips (e.g., 135).

FIG. 2 to FIG. 4 are discussed and/or illustrated using an ONFI interface (e.g., 143) as an example for accessing a NAND memory chip (e.g., 133). Alternatively, an embedded multi media card (eMMC) interface can be used.

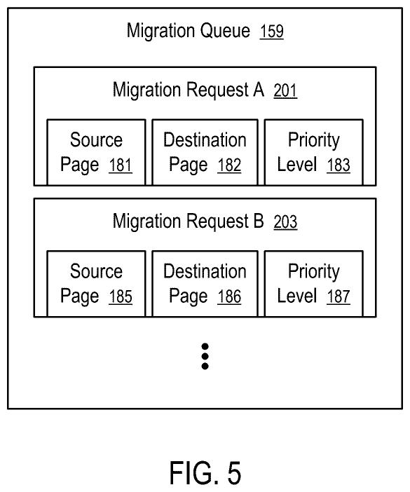

FIG. 5 illustrates a page migration queue according to one embodiment. For example, the migration queue 159 in the buffer chip 125 of FIG. 4 can be implemented in a way as illustrated in FIG. 5.

In FIG. 5, the migration queue 159 can have a plurality of slots, each configured to hold one migration request (e.g., 201 or 203).

A migration request (e.g., 201 or 203) can have a field configured to identify a source page (e.g., 181 or 185), a field configured to identify a destination page (e.g., 182 or 186), and a field configured to identify a priority level (e.g., 183 or 187) of the request (e.g., 201 or 203).

A source page (e.g., 181) can have an address in a buffer (e.g., 163 or 165), or in a memory chip (e.g., 133 or 135). A destination page (e.g., 182) can also have an address in a buffer (e.g., 163 or 165), or in a memory chip (e.g., 135 or 133). The DMA engines (e.g., 151; 164, 166) of the page migration engine 127 can transfer data between buffers 163, 165, and between buffers 153 and memory chips (e.g., 133, 135) according to the requests in the migration queue 159 and their priority levels.

For example, a memory page in a NAND memory chip can be migrated to a page (e.g., 171) in the buffer 163. The page 171 in the buffer 163 can be separated for migration into multiple pages (e.g., 174, 175, . . . ) in the buffer 165. The pages (e.g., 174, 175) in the buffer 165 can be migrated separately to one or more DRAM memory chips (e.g., 135).

Similarly, memory pages in one or more DRAM memory chips (e.g., 135) can be migrated to pages (e.g., 174, 175, . . . ) in the buffer 165. Multiple pages (e.g., 174, 175, . . . ) in the buffer 165 can be stitched together in a page 171 for further migration to a NAND memory chip (e.g., 133).

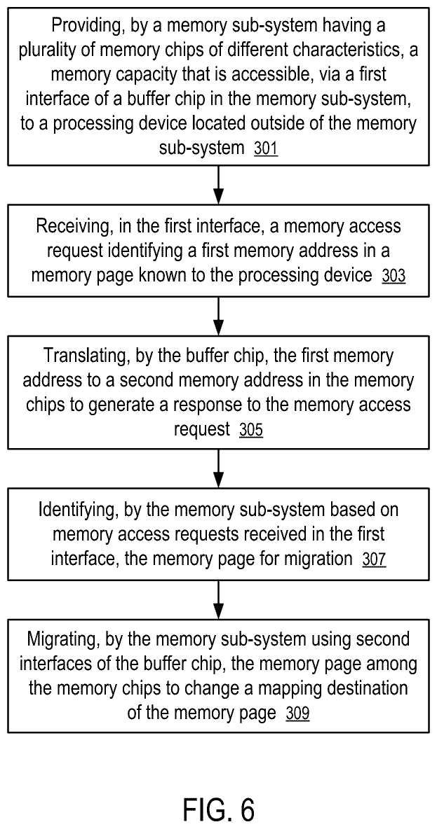

FIG. 6 shows a method of autonomous page migration within a heterogeneous memory sub-system according to one embodiment. The method of FIG. 6 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 6 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 6 can be implemented (e.g., via software, firmware and application specific circuits) as part of a memory manager 113 in the memory sub-system 101 and/or the host system 102.

For example, the memory sub-system 101 includes: a plurality of memory chips 133, . . . , 135 of different characteristics (e.g., in volatile or not, latency, bandwidth, throughput, endurance, energy consumption); and a buffer chip 125 coupled to the memory chips 133, . . . , 135. For example, each of the memory chips 133, . . . , 135 and the buffer chip 125 is a separate integrated circuit device having its own integrated circuit package. The memory sub-system 101 includes a printed circuit board having traces connected to pins of the integrated circuit devices.

For example, the buffer chip 125 includes: a first interface (e.g., 141) configured to allow a processing device 118 outside of the memory sub-system 101 to access a memory capacity of the memory sub-system 101 implemented using the memory chips 133, . . . , 135; a plurality of second interfaces (e.g., 143, 145) to the memory chips 133, . . . , 135; and a page migration engine 127 operable to migrate, among the memory chips 133, . . . , 135, a memory page as known to the processing device 118.

For example, the first interface (e.g., 141) is operable on a compute express link (CXL) connection to receive memory access requests in a CXL.mem protocol; and the second interfaces (e.g., 143, 145) can include a double data rate (DDR) interface, an open NAND flash interface (ONFI), or an embedded multi media card (eMMC) interface, or any combination thereof.

For example, the memory sub-system 101 and/or the page migration engine 127 can include a first buffer 163 having first pages 171, 172, . . . , 173 each having a first size 177 to buffer data read from or to be written to a subset of the memory chips (e.g., 133) via the open NAND flash interface (ONFI) 143. The memory sub-system 101 and/or the page migration engine 127 can further include a second buffer 165 having second pages 174, 175, . . . , 176 each having a second size 179, smaller than the first size 177, to buffer data read from or to be written to a subset of the memory chips (e.g., 135) via the double data rate (DDR) interface 145.

For example, the memory sub-system 101 and/or the page migration engine 127 can include a plurality of direct memory access (DMA) engines (e.g., 151; 164, 166) operable to access the memory chips 133, . . . , 135 through the second interfaces (e.g., 143, 145).

For example, the memory sub-system 101 and/or the page migration engine 127 can include error correction code (ECC) circuits 155 operable to generate redundant information for data written through the ONFI interface 143 and to decode data read through the ONFI interface 143.

For example, the memory sub-system 101 and/or the page migration engine 127 can include an address translation logic configured to translate a memory address received in the first interface (e.g., 141) into an address (e.g., unknown to the processing device 118) in the memory chips 133, . . . , 135 or in one of the first buffer 163 and the second buffer 165.

For example, the memory sub-system 101 and/or the page migration engine 127 can include a migration queue 159 and be operable to process page migration requests (e.g., 201, 203) in the migration queue 159 according to priority levels (e.g., 183, 187) specified for the page migration requests (e.g., 201, 203) in the queue 159. Instead of processing the requests (e.g., 201, 203) in the order of being entered into the migration queue 159, the memory sub-system 101 and/or the page migration engine 127 can take a request out of order from the queue 159 based at least in part on the priority levels (e.g., 183, 187) of the page migration requests (e.g., 201, 203).

For example, the memory sub-system 101 and/or the page migration engine 127 can include a page predictor 157 configured to generate the page migration requests (e.g., 201, 203) in response to memory access requests received in the first interface (e.g., 141).

At block 301, the method of FIG. 6 includes providing, by a memory sub-system 101 having a plurality of memory chips 133, . . . , 135 of different characteristics, a memory capacity that is accessible, via a first interface 141 of a buffer chip 125 in the memory sub-system 101, to a processing device 118 located outside of the memory sub-system 101.

For example, the first interface (e.g., 141) is operable on a compute express link (CXL) connection (e.g., to a CXL fabric 121); and the second interfaces (e.g., 143, 145) include a double data rate (DDR) interface 145, an ONFI interface 143, an embedded multi media card (eMMC) interface, or any combination thereof.

At block 303, the method includes receiving, in the first interface 141, a memory access request identifying a first memory address in a memory page known to the processing device 118.

At block 305, the method includes translating, by the buffer chip 125, the first memory address to a second memory address (e.g., unknown to the processing device 118) in the memory chips 133, . . . , 135 to generate a response to the memory access request.

At block 307, the method includes identifying, by the memory sub-system 101 based on memory access requests received in the first interface 141, the memory page for migration.

At block 309, the method includes migrating, by the memory sub-system 101 using second interfaces (e.g., 143, 145) of the buffer chip 125, the memory page among the memory chips 133, . . . , 135 to change a mapping destination of the memory page.

For example, the method of FIG. 6 can further include: buffering, in a first buffer 163 having first pages 171, 172, . . . , 173 each having a first size 177, data read from or to be written to a first subset of the memory chips (e.g., 133); and buffering, in a second buffer 165 having second pages 174, 175, . . . , 176 each having a second size 179, smaller than the first size 177, data read from or to be written to a second subset of the memory chips (e.g., 135).

For example, the buffer chip 125 can include a plurality of direct memory access (DMA) engines 151, including a first subset (e.g., DMA engines 164) configured to use the first buffer 163 and a second subset (e.g., DMA engines 166) configured to use the second buffer 165. The DMA engines 151 are each configured to perform the transfer of one page (e.g., 171 or 174) from a buffer (e.g., 163 or 165) to or from a memory chip (e.g., 133 or 135) at a time. The sizes 177 and 179 are optimized for performance in such transfers to respective memory chips (e.g., 133 or 135).

For example, the method of FIG. 6 can further include: generating, using error correction code (ECC) circuits 155 in the buffer chip 125, redundant information for data written to the memory chips (e.g., 133) via the first buffer (e.g., 163); and decoding, using the error correction code (ECC) circuits 155, data read from the memory chips (e.g., 133) into the first buffer 163.

For example, the method of FIG. 6 can further include: generating, in a migration queue 159, a plurality of page migration requests (e.g., 201, 203) to migrate memory pages among the memory chips (e.g., 133, 135); and determining an order to execute the page migration requests (e.g., 201, 203) in the migration queue 159 based on priority levels (e.g., 183, 187) of the page migration requests (e.g., 201, 203).

For example, the method of FIG. 6 can further include: combining a plurality of page migration requests of migrating a plurality of pages (e.g., 174, 175, . . . ) from the second subset of the memory chips (e.g., 135) into a page migration request of migrating to a page (e.g., 171) in the first subset of the memory chips (e.g., 133).

For example, the method of FIG. 6 can further include: generating a plurality of page migration requests of migrating a plurality of pages (e.g., 174, 175, . . . ) to the second subset of the memory chips (e.g., 135) to implement a page migration request of migrating to a page (e.g., 171) in the first subset of the memory chips (e.g., 133).

In at least some embodiments, page migrations in a plurality of memory sub-systems (e.g., 101) connected to a compute express link (CXL) fabric 121 are coordinated to optimize the usages of the communications bandwidth offered by the CXL fabric 121, to optimize the usages of memory resources in the memory sub-systems (e.g., 101), to balance the workloads of the memory sub-systems (e.g., 101), and to improve the overall performance of the secondary random access memory 112 provided via the CXL fabric 121.

A multi-module coordinated page migration engine, or migration coordinator, can be configured to optimize data movements in a distributed memory sub-systems (e.g., 101) connected to a compute express link (CXL) fabric 121.

For example, while the host system 102 is accessing a portion of the secondary random access memory 112 over the CXL fabric 121, some of the connections in the compute express link (CXL) fabric 121 can be idling. The migration coordinator can identify idling connections among some of the memory sub-systems (e.g., 101) and use the connections for page migrations among the memory sub-systems (e.g., 101).

In general, different memory sub-systems (e.g., 101) have different amounts of free faster memory cells (e.g., DRAM memory cells 138) that are available for hosting memory pages in active use. The migration coordinator can structure page migrations across memory sub-systems (e.g., 101) connected to the compute express link (CXL) fabric 121 to optimize the usages of the faster memory cells (e.g., DRAM memory cells 138).

For example, due to the connection topology of the memory sub-systems (e.g., 101) in the compute express link (CXL) fabric 121, accessing the same type of faster memory cells (e.g., DRAM memory cells 138) in different memory sub-systems (e.g., 101) can have different levels of communication delay and thus different levels of latency performance. However, accessing the faster memory cells (e.g., DRAM memory cells 138) in a memory sub-system that has a higher level of communication delay over the CXL fabric 121 can still be faster than accessing a slower memory cells (e.g., NAND memory cells 136) in a memory sub-system that has a lower level of communication delay over the CXL fabric 121.

Thus, in some instances, it can be advantageous to migrate a memory page from the faster memory cells (e.g., DRAM memory cells 138) in a memory sub-system that has a lower level of communication delay over the CXL fabric 121 to the faster memory cells (e.g., DRAM memory cells 138) in another memory sub-system that may have a higher level of communication delay over the CXL fabric 121, in comparison with migrating the memory page within the memory sub-system that has a lower level of communication delay over the CXL fabric 121.

In some instances, it can be advantages to migrate a memory page from the faster memory cells (e.g., DRAM memory cells 138) in a memory sub-system that has a higher level of communication delay over the CXL fabric 121 to the faster memory cells (e.g., DRAM memory cells 138) in another memory sub-system that has a lower level of communication delay over the CXL fabric 121 to improve latency performance for the host system 102 to access the memory page.

In some instances, it can be advantageous to migrate a memory page from the slower memory cells (e.g., NAND memory cells 136) in a source memory sub-system that has a lower level of communication delay over the CXL fabric 121 to the faster memory cells (e.g., DRAM memory cells 138) in a destination memory sub-system that has a higher level of communication delay over the CXL fabric 121, when the destination memory sub-system currently has more free faster memory cells (e.g., DRAM memory cells 138) available than the source memory sub-system.

In some instances, it can be advantageous to migrate a memory page between a source memory sub-system and a destination memory sub-system to increase the workload of the destination memory sub-system and decrease the workload of the source memory sub-system and thus balance the workloads of the memory sub-systems.

For example, a migration coordinator can be configured in a controller of, or a switch in, the compute express link (CXL) fabric 121. Optionally, the migration coordinator can be implemented in a board management controller (BMC) (e.g., a dedicated microcontroller or processor that is integrated into the motherboard of a server computer).

The migration coordinator can monitor the communications traffic in the fabric 121 and/or the workloads of the memory sub-systems (e.g., 101) in the computing system 100 to select destination memory sub-systems for memory pages to be migrated. The destination memory sub-systems can be selected to reduce the impact of the migration activities on servicing the memory access requests received in the fabric 121 from the processing device(s) 118.

The migration coordinator can implement multi-page coordination and cross-module migration capabilities in the computing system 100 having multiple memory sub-systems (e.g., 101). The migration coordination can include efficient bulk data move movements across the memory sub-systems (e.g., 101) while maintaining coherency and optimizing system resources.

For example, the migration coordinator can group the transfers of data for multiple pages in bulk to improve efficiency over single page migration. In some instances, the migration coordinator can implement the bulk data transfer in combination with data access in response to memory access requests from the processing device(s) 118 to reduce the traffic and/or repetition of data communications in the fabric 121.

The migration coordinator can implement bulk data transfers to maintain coherency, reduce bandwidth bottlenecks in cross-module transfers, and improve power and thermal efficiency during the transfer of large amounts of data across memory sub-systems.

The migration coordinator can include hardware configured to manage and coordinate the data migration cross multiple memory sub-systems (e.g., 101). For example, the migration coordinator can have a tracking table, a sequencer, a resource allocator, and a power and thermal monitoring array. A bulk data transfer engine can be used by the migration coordinator to implement bulk data movements. The bulk data transfer engine can include hardware configured to create a page group for tracking related pages together, manage dependencies, schedule transfers, allocate resources, and handle the data movements. The bulk data transfer engine can migrate memory pages in groups in coordinated transfers of data across the memory sub-systems.

For example, the migration coordinator can receive a set of page migration requests from the memory sub-systems 101 and/or the host system 102. The migration coordinator can identify the source locations and destination locations of the memory pages for migration and create related groups based on the locations. The migration coordinator can lock the data at the source locations against modification, allocate buffers for temporary storage of the data, and schedule the movement of the data to the destination locations. The migration coordinator can initiate the movement of a group of pages across multiple memory sub-systems, while keeping track of pages and tracking tables. Optionally, after the data movement, the migration coordinator can perform a data integrity verification to ensure the data movement is complete and correct. For example, the migration coordinator can compare the hash value of the data at the designation locations against the hash value of the data at the source locations to detect error and to perform corrections when the data integrity verification fails (e.g., the hash values do not match with each other). After the migration, the migration coordinator can release the lock on the memory pages and update the tracking tables.

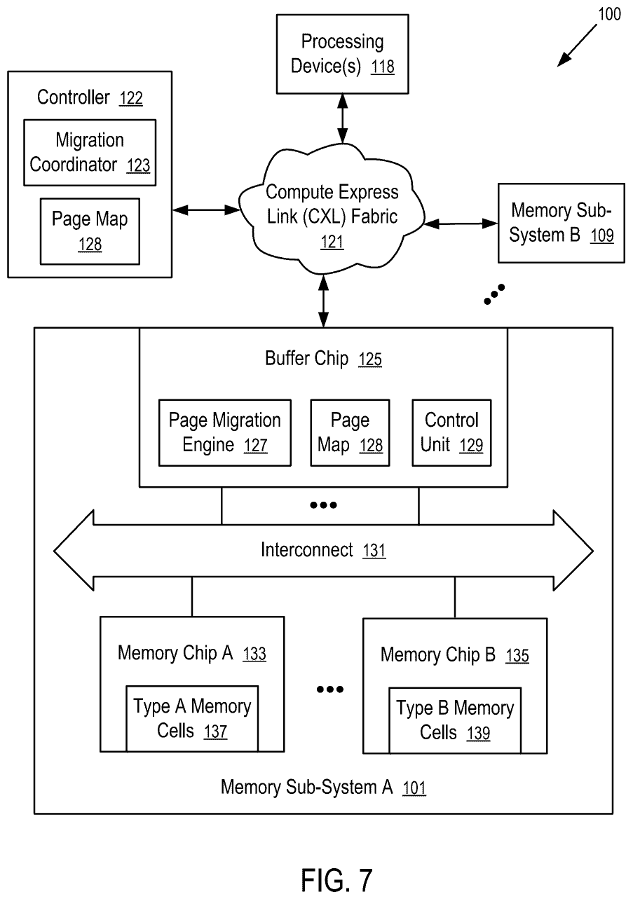

FIG. 7 shows a controller of a compute express link fabric configured with a migration coordinator according to one embodiment. For example, the controller 122 of FIG. 7 can be used to coordinate migration of memory pages among memory sub-systems (e.g., 101 in FIG. 1 to FIG. 3).

In FIG. 7, a plurality of memory sub-systems (e.g., 101, . . . , 109) are connected to a compute express link (CXL) fabric 121 to implement a secondary random access memory 112 in a computing system 100.

Each of the memory sub-systems (e.g., 101) can include a page migration engine 127 (e.g., as in FIG. 2 to FIG. 6) to identify memory pages for migration and/or to perform page migration within the respective memory sub-system (e.g., 101).

A migration coordinator 123 can be configured in the controller 122 of the compute express link (CXL) fabric to coordinate page migration operations across the memory sub-systems 101, . . . , 109.

For example, a page migration engine 127 of each memory sub-system 101 can send migration requests (e.g., 201, 203) in its migration queue (e.g., 159) to the migration coordinator 123 for consideration of cross-module migrations. Based on the communications traffic in the fabric 121, the workloads of the memory sub-systems 101, . . . , 109, and the pending migration requests received from the different memory sub-systems 101, . . . , 109, the migration coordinator 123 can determine preferred destinations of the pages to be migrated.

When a destination of migration of a memory page as decided by the migration coordinator 123 is within the same memory sub-system (e.g., 101) of the source location of the memory page, the migration coordinator 123 can send the migration request to the memory sub-system 101; and the page migration engine 127 in the memory sub-system 101 can perform the page migration without increasing communications traffic in the compute express link (CXL) fabric 121.

When the source and destination locations of a page migration are in different memory sub-systems (e.g., 101 and 109), the migration coordinator 123 can schedule the data transfer between the memory sub-systems (e.g., 101 and 109) to reduce or eliminate the impact of the communications traffic resulting from the data transfer on servicing the memory access requests of the processing device(s) 118 received in the compute express link (CXL) fabric 121.

For example, the controller 122 can allocate a buffer memory to store the data temporary. When the communication path between the buffer memory and the source memory sub-system (e.g., 109) of the page migration is not used in servicing the memory access requests from the processing device 118, the controller 122 can fetch the data from the source memory sub-system (e.g., 109) to the buffer memory. Subsequently, when the communication path between the buffer memory and the destination sub-system (e.g., 101) of the page migration is not used in servicing the memory access requests from the processing device 118, the controller 122 can store the data from the buffer memory to the destination memory sub-system (e.g., 101).

For example, the buffer memory can be a portion of the random access memory in the controller 122. Alternatively, the buffer memory can be allocated from a memory sub-system that is between a communication path from the source memory sub-system 109 through the compute express link (CXL) fabric 121 to the destination memory sub-system 109.

In some implementations, the controller 122 is configured with a page map 128 and operable to direct the switch(es) in the compute express link (CXL) fabric 121 to route memory access requests from and memory access responses to the processing device(s) 118.

Optionally, a cache coherent memory access protocol is used for the memory access through the compute express link (CXL) fabric 121; and the migration coordinator 123 can dynamically configure caches of memory pages to be migrated to facilitate the data transfer between the memory sub-systems 101, . . . , 109.

For example, to migrate a page from a source memory sub-system 109 to a destination memory sub-system 101, the migration coordinator 123 can set up a page in the memory sub-system 101 as a cache page of the source page in the memory sub-system 109. When the processing device 118 accesses the memory page in the source memory sub-system 101, a copy of at least a portion of the content of the memory page is cached in the page in the memory sub-system 101. Such an arrange can reduce or eliminate duplicate data transfers along at least a portion of a communications path between the source memory sub-system 109 and the destination memory sub-system 101.

Optionally, the migration coordinator 123 can group the transfer of data of multiple pages based on the source location of the data transfer and the destination location of the data transfer and schedule the data transfer in selected time periods to reduce or eliminate the impact of the data transfer on servicing the processing device(s) (e.g., 118).

For example, the migration coordinator 123 can group the data of multiple pages from a same source memory sub-system (e.g., 109) for transferring to a buffer memory, even though the pages have different destination memory sub-systems (e.g., 101) for their migration.

For example, the migration coordinator 123 can group the data of multiple pages for transferring from a buffer memory to a same destination memory sub-system (e.g., 101), even though the pages have different source memory sub-systems (e.g., 109) for their migration.

In some implementations, the migration coordinator 123 includes a direct memory access (DMA) engine operable to perform the bulk data transfer to or from the buffer memory.

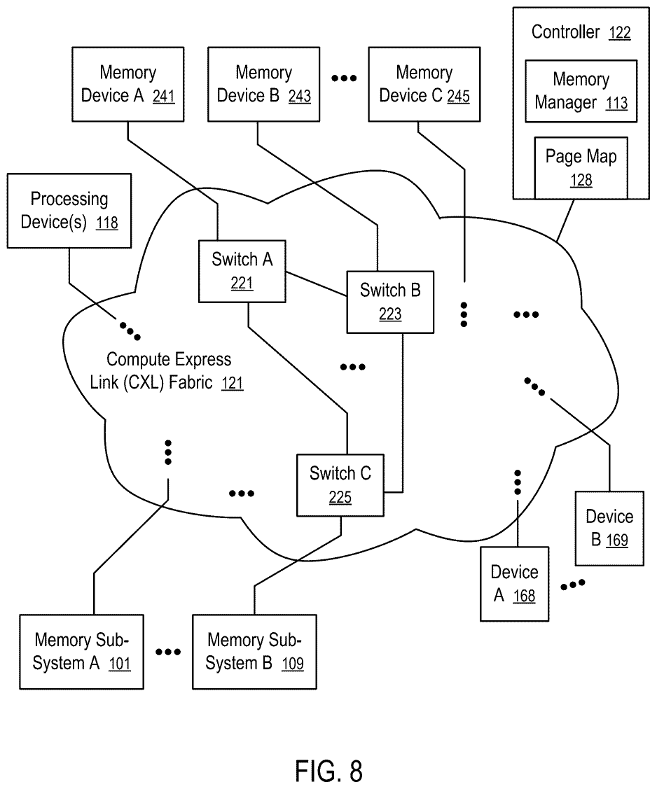

FIG. 8 shows a compute express link fabric configured with a controller to coordinate page migrations according to one embodiment. For example, the compute express link fabric 121 discussed above in connection with FIG. 1 to FIG. 3 and FIG. 7 can be implemented as in FIG. 8.

In FIG. 8, the compute express link fabric 121 includes a plurality compute express link switches (e.g., 221, 223, 225). Each of the switches (e.g., 221, 223, or 225) has a plurality of ports connected to separate compute express link connections. A switch (e.g., 221, 223, or 225) is configured to route a memory access request or response received at one port to another. A compute express link connection in the fabric 121 can connect a port of one switch to a port of another switch, or to a memory device (e.g., 241, 243, or 245), or to a memory sub-system (e.g., 101, or 109), or to a host processor, such as a processing device 118 (e.g., a CPU, a CPU core, an SoC) or another device (e.g., 168 or 169, such as a GPU, a GPU core, an AI accelerator).

A controller 122 of the fabric 121 can control the switches (e.g., 221, 223, or 225) of the fabric 121 to implement a page map 128 for routing memory access requests having addresses specified by a host processor (e.g., processing device 118, or device 168 or 169) into addresses of random access memory cells in the memory devices 241, 243, . . . , 245 and the memory sub-systems 101, . . . , 109.

The controller 122 can include a fabric manager and/or a memory manager 113 to adjust the page map 128 for implementing a random access memory 112 in a secondary memory tier using memory resources in the memory devices 241, 243, . . . , 245 and the memory sub-systems 101, . . . , 109. Optionally, the memory resources are provided by the memory devices 241, 243, . . . , 245 and the memory sub-systems 101, . . . , 109 in the form of dynamic capacity devices attached to the controller 122 over the fabric 121. Alternatively, the memory resources can be provided by the memory devices 241, 243, . . . , 245 and the memory sub-systems 101, . . . , 109 via random access memory cells addressable by the controller 122 without the use of the dynamic capacity devices offered by the memory devices 241, 243, . . . , 245 and the memory sub-systems 101, . . . , 109; and thus, the techniques can be used even when the memory devices 241, 243, . . . , 245 and/or the memory sub-systems 101, . . . , 109 do not implement the functions and protocols of dynamic capacity devices.

In some implementations, the memory manager 113 (and/or the fabric manager) is configured on a centralized device in communication with the switches 221, 223, . . . , 225 in the fabric 121. In other implementations, the memory manager 113 (and/or the fabric manager) is implemented via a set of agents each running in one of the switches 221, 223, . . . , 225. The agents can be configured to make separate and independent routing decisions. The agents can collectively implement the operations of the controller 122 by each routing memory access traffic from one port of a switch to another port of the same switch in which the agent is running.

The controller 122 of the compute express link fabric 121 (e.g., as discussed above in connection with FIG. 1 to FIG. 3 and FIG. 7) can monitor the changing memory/storage usage patterns and/or the real time performance level of the random access memory 112 in the secondary tier memory of a host processor (e.g., device 118, 168, or 169). Based on the real time performance level and/or the memory/storage usage patterns, the controller 122 can dynamically select destinations of page migration requests received from the memory sub-systems 101, . . . , 109 and/or select memory pages for migration across the memory sub-systems 101, . . . , 109 for improved overall performance of the secondary random access memory 112.

Optionally, the controller 122 can allocate buffer memories from the memory devices 241, 243, . . . , 245 and/or the memory sub-systems 101, . . . , 109 to store data temporarily for memory pages being migrated across the memory sub-systems 101, . . . , 109.

Optionally, the controller 122 is configured with a buffer memory that can be used to temporarily store data of memory pages being migrated across the memory sub-systems 101, . . . , 109.

Optionally, the controller 122 can set up cache pages of source memory pages being migrated to move data from the source memory pages in connection with a host processor (e.g., device 118, 168, 169) accessing the source memory pages to facilitate page migration. The cache pages can be set up in the destinations of page migration or on communications paths between the sources and destinations of the page migration.

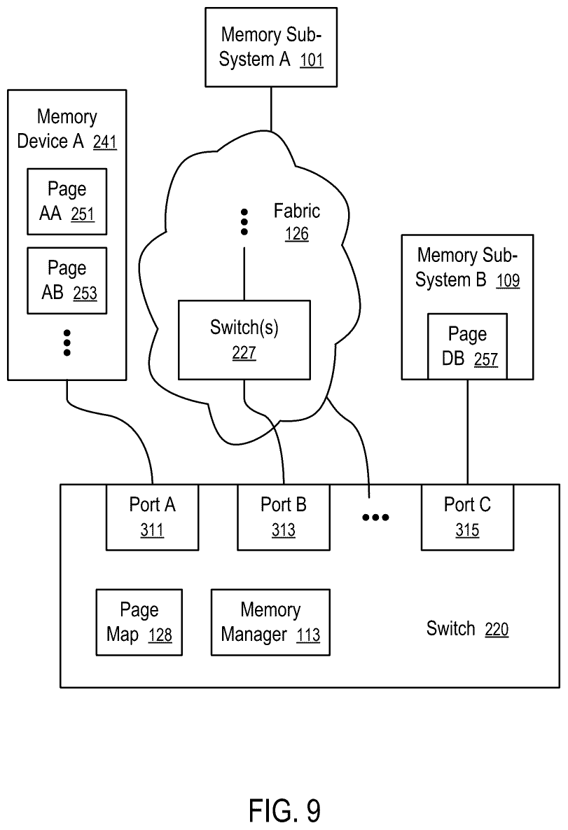

FIG. 9 shows a compute express link switch 220 configured to implement a memory manager 113 according to one embodiment. For example, a memory manager 113 running as an agent of the controller 122 of a compute express link fabric 121 as in FIG. 8 can be implemented in each of the switches 221, 223, . . . , 225 in the fabric 121.

The compute express link fabric switch 220 in FIG. 9 can have a plurality of ports 311, 313, . . . , and 315. A port (e.g., 311) of the switch 220 can be connected to a memory device (e.g., 241) or a memory sub-system (e.g., 101). Such a port can be considered a device-connected port (e.g., 311). When a memory address in a memory access request is mapped to the memory device (e.g., 241) attached to the port (e.g., 311), the switch 220 routes the memory access request to the port (e.g., 311).

A port (e.g., 313) of the switch 220 can be connected to another switch (e.g., 225 or 227). Such a port (e.g., 313) can be considered a switch-connected port (e.g., 313). When a memory address in a memory access request is not mapped to the memory device (e.g., 241) attached to the port (e.g., 313), the switch 220 can route the memory access request to a switch-connected port (e.g., 313). A set of switches (e.g., 227) connected to the switch-connected port(s) (e.g., 313) of the switch 220 can be considered a fabric 126. In general, the switch 220 can have the options to route such a memory access request to more than one switch-connected port (e.g., 315) of the switch 220.

Optionally, the switch 220 can have a memory manager 113 configured to map memory access requests to its ports 311, 313, . . . , 315 according to its page map 128. Alternatively, a controller 122 configured separately from the switch 220 can provide data to instruct the switch 220 in routing the memory access requests coming into ports of the switch 220.

For example, the page map 128 in the switch 220 and/or in the controller 122 can be configured to indicate that a page of memory addressable by a host processor (e.g., devices 118, 168, 169) is mapped to a page 251 (or 253) in the memory device 241. When a memory access request received in the switch 220 is in such a page of memory, the switch 220 route the request to the port 311 toward the memory device 241.

For example, the page map 128 in the switch 220 and/or in the controller 122 can be configured to indicate that a page of memory addressable by a host processor (e.g., devices 118, 168, 169) is mapped to a page 257 in the memory sub-system 109. When a memory access request received in the switch 220 is in such a page of memory, the switch 220 route the request to the port 315 toward the memory sub-system 109.

Since the page map 128 can be adjusted and/or updated in the switch 220 and/or in the controller 122 without a need to restart the computing system 100 or a portion of it, the memory manager 113 in the controller 122 and/or the switch 220 can migrate memory pages across the different memory sub-systems 101, . . . , 109 without a need to restart the computing system 100 and/or the host processor (e.g., device 118, 168, 169).

For example, when a memory page is migrated from the source memory sub-system 101 to the destination memory sub-system 109, the page map 128 in the switch 220 can be updated such that a memory address to the memory page previously directed to the port 313 is instead directed to the port 315.

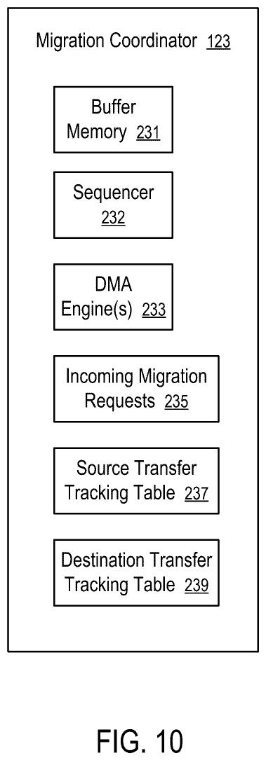

FIG. 10 shows a migration coordinator according to one embodiment. For example, the migration coordinator 123 in FIG. 7 can be implemented in a way as illustrated in FIG. 10. For example, the memory manager 113 in FIG. 8 and/or FIG. 9 can implement a migration coordinator 123 as in FIG. 10.

In FIG. 10, the migration coordinator 123 can include a buffer memory 231, one or more direct memory access (DMA) engine 233, a queue to store incoming migration requests 235, a tracking table 237 for transfers scheduled to move data from memory pages hosted in source memory sub-systems (e.g., 101, 109) to the buffer memory 231, and a tracking table 239 for transfers scheduled to move data from the buffer memory 231 to destination memory sub-systems (e.g., 109, 101).

For example, the buffer memory 231 can include a first plurality of pages of the size 179 for the movement of data to or from faster memory chips (e.g., 135) in the memory sub-systems (e.g., 101, 109) and a second plurality of pages of the size 177 for the movement of data to or from slower memory chips (e.g., 133) in the memory sub-system (e.g., 101, 109).

Optionally, the migration coordinator 123 can be configured in a chip (e.g., in a way similar to a buffer chip 125 in FIG. 4 but without a need for the ONFI interfaces 143 and DDR interfaces 145). The chip of the migration coordinator 123 can have one or more interfaces to switches (e.g., 221, 223) in the fabric 121 and/or to ports (e.g., 311, 315) of a switch (e.g., 220). Through the interface(s), the DMA engines 233 can move data between the buffer memory 231 and the memory sub-systems 101, . . . , 109 connected to the fabric 121.

Optionally, the migration coordinator 123 can allocate buffer memories from the memory devices 241, 243, . . . , 245 to facilitate the data transfers in page migration.

Optionally, the migration coordinator 123 can set up cache pages of memory pages in the memory sub-systems 101 to facilitate the data transfers in page migration. For example, a cache page can be set up in a destination memory sub-system 109 to cache data of a memory page hosted in a source memory sub-system 101 to facilitate the copy of data between the memory sub-systems 101 and 109; and after synchronizing the data between the cache page and the memory page, the migration coordinator 123 can change the page map 128 to map the memory page to the destination memory sub-system 109. Alternatively, the migration coordinator 123 can map the memory page to the destination memory sub-system 109 and set the page in the source memory sub-system 101 as the cache page for the memory page; and the migration coordinator 123 can indicate that the cache page is dirty (e.g., having data newer than the content in the memory page) to cause the flushing of the data in the cache page to the destination memory sub-system 109.

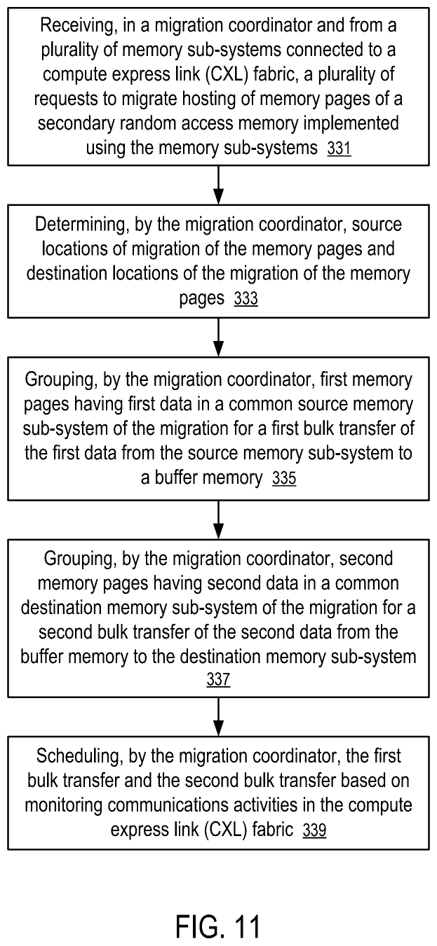

FIG. 11 shows a method to migrate pages across memory sub-systems according to one embodiment. The method of FIG. 11 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 11 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 11 can be implemented (e.g., via software, firmware and application specific circuits) as part of a memory manager 113 in the memory sub-system 101 and/or the host system 102.

For example, the computing system 100 can have a main memory 124 and a secondary random access memory 112 provided via memory devices (e.g., 241, 243, . . . , 245) and memory sub-systems (e.g., 101, . . . , 109) connected via a compute express link fabric 121. The memory sub-systems (e.g., 101, . . . , 109) connected to the compute express link fabric 121 can each have memory chips (e.g., 133, 135) of different characteristics (e.g., in latency, power consumption, endurance, bandwidth, throughput) to host memory pages of the secondary random access memory 112. A migration coordinator 123 is configured in the computing system 100 to manage migration of hosting of memory pages across the memory sub-systems 101, . . . , 109.

For example, the migration coordinator 123 can be configured in a controller 122 of the compute express link fabric 121, a switch 220 in the compute express link fabric 121, or a board management controller (BMC) of the computing system 100.

For example, the migration coordinator 123 is configured to receive page migration requests 235 from the memory sub-systems 101, . . . , 109 to identify source locations of the hosting of the memory pages to be migrated and determine destination locations of the migration of the hosting of the memory pages. For example, the page migration requests 235 can be identified by page migration engines 127 in the memory sub-systems 101, . . . , 109, and/or by the controller 122 of the fabric 121 based on memory access patterns as observed in the memory sub-systems 101, . . . , 109 and/or in the fabric 121.

For example, the migration coordinator 123 can include a direct memory access (DMA) engine 233 configured to move data from the source locations to the destination locations. For example, the data can be moved via a buffer memory 231 in the migration coordinator 123. Alternatively, the buffer memory 231 can be allocated from one or more memory devices (e.g., 241, 243, . . . , 245) connected to the fabric 121 and/or one or more memory sub-systems (e.g., 101, 109). Data received from the source locations can be stored temporarily before the data is sent to the destination locations.

For example, the migration coordinator 123 can be configured to group data of multiple first memory pages for transmitting in bulk from a source memory sub-system (e.g., 109) to the buffer memory 231 and group data of multiple second pages for transmitting in bulk from the buffer memory 231 to a destination memory sub-system (e.g., 101). The first memory pages can be migrated from the common source memory sub-system (e.g., 109) to different destination memory sub-systems; and the use of the buffer memory 231 can provide a common temporary destination for the transfer of data from the common source memory sub-system (e.g., 109). Similarly, the second memory pages can be migrated to the command destination memory sub-system (e.g., 101) from different source memory sub-systems; and the use of the buffer memory 231 can provide a command temporary source for the transfer of data to the command destination memory sub-system (e.g., 101).

The grouping of data transfer via the use of the buffer memory 231 can simplify the scheduling of data transfer over the fabric 121 using communication paths that would be idling in absence of the page migration activities.

For example, the migration coordinator 123 can include: a buffer memory 231; a sequencer 232; and a direct memory access (DMA) engine 233 operable on the compute express link (CXL) fabric 121 that connects the plurality of memory sub-systems 101, . . . , 109. The sequencer 232 is configured is configured to manage migration of first memory pages across the plurality of memory sub-systems 101, . . . , 109.

For example, each of the memory sub-systems 101, . . . , 109 can have at least a first memory chip 133 of a first type (e.g., NAND) and a second memory chip 135 of a second type (e.g., DRAM) to host, using at least the first memory chip (e.g., 133) and the second memory chip (e.g., 135), memory pages of the secondary random access memory 112.

Optionally, the sequencer 232 is configured to identify destinations of the migration of the first memory pages across the plurality of memory sub-systems 101, . . . , 109. For example, after receiving migration requests 235 from the memory sub-systems 101, . . . , 109 and/or the controller 122, the migration coordinator 123 can identify preferred destinations of the migration to improve the overall performance of the secondary random access memory 112 in servicing the host process(s) (e.g., devices 118, 168, 169), and/or to balance the workloads of the memory sub-systems 101, . . . , 109.

Optionally, the sequencer 232 is configured to group data transfers according to common communication paths to the buffer memory 231 for retrieving data of the first memory pages and according to common communication paths from the buffer memory 231 for storing data of the first memory pages.

Optionally, the sequencer 232 is further configured to track, using the buffer memory 231, progress of data transfers involved in the migration.

Optionally, the sequencer 232 is further configured to set, in the memory sub-systems 101, . . . , 109, cache pages for the first memory pages to implement the migration in connection with servicing memory access requests from the host processors (e.g., devices 118, 168, 169) and directed to the first memory pages.

At block 331, the method of FIG. 11 includes receiving, in a migration coordinator 123 and from a plurality of memory sub-systems 101, . . . , 109 connected to a compute express link (CXL) fabric 121, a plurality of requests 235 to migrate hosting of memory pages of a secondary random access memory implemented using the memory sub-systems.

For example, at least some of the requests 235 are received from migration engines (e.g., 127) configured in the plurality of memory sub-systems 101, . . . , 109; and the method of FIG. 11 can further includes: determining, by the migration coordinator 123, destination memory sub-systems of the migration responsive to the requests.

For example, the determining of the destination memory sub-systems can be based on: communications traffic in the compute express link (CXL) fabric 121; amounts of free memory resources available to host memory pages in the plurality of memory sub-systems 101, . . . , 109; or workloads of the plurality of memory sub-systems 101, . . . , 109; or any combination thereof.

At block 333, the method includes determining, by the migration coordinator 123, source locations of migration of the memory pages and destination locations of the migration of the memory pages.

At block 335, the method includes grouping, by the migration coordinator 123, first memory pages having first data in a common source memory sub-system (e.g., 109) of the migration for a first bulk transfer of the first data from the source memory sub-system (e.g., 109) to a buffer memory 231.

At block 337, the method includes grouping, by the migration coordinator 123, second memory pages having second data in a common destination memory sub-system (e.g., 101) of the migration for a second bulk transfer of the second data from the buffer memory 231 to the destination memory sub-system (e.g., 101).

At block 339, the method includes scheduling, by the migration coordinator 123, the first bulk transfer and the second bulk transfer based on monitoring communications activities in the compute express link (CXL) fabric 121.

Optionally, the method of FIG. 11 can further include: allocating the buffer memory from one of the plurality of memory sub-systems 101, . . . , 109 (or a memory device (e.g., 241, 243, or 245) connected to the compute express link (CXL) fabric 121).

For example, each of the source memory sub-system (e.g., 109) and the destination memory sub-system (e.g., 101) can include: a first memory chip (e.g., 133) having memory cells (e.g., 136) of a first type (e.g., NAND or NOR flash memory); a second memory chip (e.g., 135) having memory cells (e.g., 138) of a second type (e.g., dynamic random access memory (DRAM) or static random access memory (SRAM)) different from the first type (e.g., flash memory); and a page migration engine 127 operable to migrate memory pages between the first memory chip (e.g., 133) and the second memory chip (e.g., 135).

Optionally, the method of FIG. 11 can further include: detecting, by the migration coordinator 123, an error in the migration based on comparing a first hash value of data at the source locations (e.g., in the memory sub-system 109 as a migration source) and a second hash value of data at the destination locations (e.g., in the memory sub-system 101 as a migration destination).

A non-transitory computer storage medium can be used to store instructions programmed to implement a memory manager 113 configured to perform operations discussed above in connection with the memory sub-system 101. When the instructions are executed by the processing device (e.g., 117, 118), and/or the controller (e.g., 115, 122) the instructions cause the computing system 100 to perform the methods discussed above.

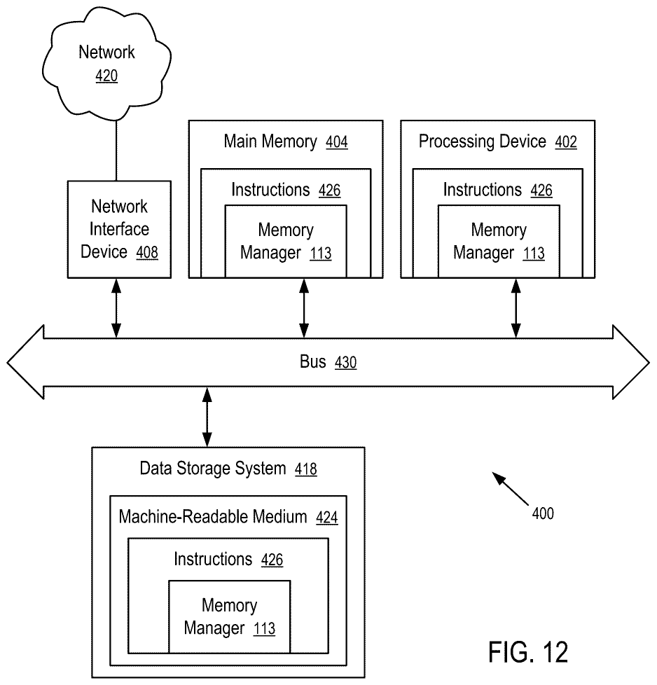

FIG. 12 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of memory managers 113 (e.g., to execute instructions to perform operations corresponding to the memory managers 113 described with reference to FIGS. 1-11). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the memory managers 113 described with reference to FIGS. 1-11. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A system, comprising:
a compute express link fabric;
a plurality of memory sub-systems connected to the compute express link fabric to implement a secondary random access memory, each of the memory sub-systems having memory chips of different characteristics to host memory pages of the secondary random access memory.

2. The system of claim 1, further comprising:
a migration coordinator configured to manage migration of hosting of memory pages across the memory sub-systems;
wherein the migration coordinator is configured to receive page migration requests from the memory sub-systems to identify source locations of the hosting of the memory pages and determine destination locations of the migration.

3. The system of claim 2, wherein the migration coordinator includes a direct memory access (DMA) engine configured to move data from the source locations to the destination locations.

4. The system of claim 3, wherein the migration coordinator further includes a buffer memory configured to store the data received from the source locations before being sent to the destination locations.

5. The system of claim 4, wherein the migration coordinator is configured to group data of multiple first memory pages for transmitting in bulk from a source memory sub-system to the buffer memory and group data of multiple second pages for transmitting in bulk from the buffer memory to a destination memory sub-system;
wherein the first memory pages are migrated to different destination memory sub-systems; and
wherein the second memory pages are migrated from different source memory sub-systems.

6. The system of claim 5, wherein the migration coordinator is configured in a controller of the compute express link fabric.

7. The system of claim 5, wherein the migration coordinator is configured in a switch in the compute express link fabric.

8. The system of claim 5, wherein the migration coordinator is configured in a board management controller (BMC).

9. A method, comprising:
receiving, in a migration coordinator and from a plurality of memory sub-systems connected to a compute express link (CXL) fabric, a plurality of requests to migrate hosting of memory pages of a secondary random access memory implemented using the memory sub-systems;
determining, by the migration coordinator, source locations of migration of the memory pages and destination locations of the migration of the memory pages; and
grouping, by the migration coordinator, first memory pages having first data in a common source memory sub-system of the migration for a first bulk transfer of the first data from the source memory sub-system to a buffer memory

10. The method of claim 9, further comprising:
grouping, by the migration coordinator, second memory pages having second data in a common destination memory sub-system of the migration for a second bulk transfer of the second data from the buffer memory to the destination memory sub-system;
scheduling, by the migration coordinator, the first bulk transfer and the second bulk transfer based on monitoring communications activities in the compute express link (CXL) fabric; and
allocating the buffer memory from one of the plurality of memory sub-systems.

11. The method of claim 9, wherein each of the source memory sub-system and the destination memory sub-system includes:
a first memory chip having memory cells of a first type;
a second memory chip having memory cells of a second type different from the first type; and
a page migration engine operable to migrate memory pages between the first memory chip and the second memory chip.

12. The method of claim 11, wherein the first type is a flash memory; and the second type is a dynamic random access memory (DRAM) or static random access memory (SRAM).

13. The method of claim 12, wherein the requests are received from migration engines configured in the plurality of memory sub-systems; and the method further comprises:
determining, by the migration coordinator, destination memory sub-systems of the migration responsive to the requests.

14. The method of claim 13, wherein the determining of the destination memory sub-systems is based on:
communications traffic in the compute express link (CXL) fabric;
amounts of free memory resources of the second type available to host memory pages in the plurality of memory sub-systems; or
workloads of the plurality of memory sub-systems; or
any combination thereof.

15. The method of claim 14, further comprising:
detecting, by the migration coordinator, an error in the migration based on comparing a first hash value of data at the source locations and a second hash value of data at the destination locations.

16. A migration coordinator, comprising:
a sequencer;
a buffer memory; and
a direct memory access (DMA) engine operable on a compute express link (CXL) fabric connecting a plurality of memory sub-systems, each of the memory sub-systems having at least a first memory chip of a first type and a second memory chip of a second type and configured to host, using at least the first memory chip and the second memory chip, memory pages of a secondary random access memory.

17. The migration coordinator of claim 16, wherein the sequencer is configured to manage migration of first memory pages across the plurality of memory sub-systems; and
wherein the sequencer is configured to identify destinations of the migration.

18. The migration coordinator of claim 17, wherein the sequencer is further configured to group data transfers according to common communication paths to the buffer memory for retrieving data of the first memory pages and according to common communication paths from the buffer memory for storing data of the first memory pages.

19. The migration coordinator of claim 17, wherein the sequencer is configured to track, using the buffer memory, progress of data transfers involved in the migration.

20. The migration coordinator of claim 17, wherein the sequencer is configured to set, in the memory sub-systems, cache pages for the first memory pages to implement the migration in connection with servicing memory access requests directed to the first memory pages.
